(19) United States
(12) Patent Application Publication
(10) Pub. No.: US 2023/0317914 A1
(43) Pub. Date: Oct. 5, 2023

(54) ALL-SOLID-STATE BATTERY HAVING ANODE LAYER CONTAINING INTERPARTICULAR PORES AND OPERATING METHOD THEREOF

(71) Applicants: Hyundai Motor Company, Seoul (KR); Kia Corporation, Seoul (KR); Industry-University Cooperation Foundation Hanyang University, Seoul (KR)

(72) Inventors: Ki Yoon Bae, Seoul (KR); Sam Ick Son, Suwon (KR); Yun Jung Lee, Seoul (KR); Se Hwan Park, Seoul (KR); Da Young Jun, Seoul (KR); Seong Gyu Lee, Seoul (KR)

(21) Appl. No.: 18/078,818

(22) Filed: Dec. 9, 2022

(30) Foreign Application Priority Data
Mar. 29, 2022 (KR) 10-2022-0038483

(51) Int. Cl. H01M 4/04; H01M 4/62; H01M 10/0562; H01M 4/38

(52) U.S. Cl. CPC H01M 4/043; H01M 4/38; H01M 4/625; H01M 10/0562; H01M 2004/027

(57) ABSTRACT

Disclosed are an all-solid-state battery having an anode layer including interparticular pores and a driving method thereof. The all-solid-state battery may include: an anode current collector; an anode layer which is positioned on the anode current collector and includes particles that do not have lithium ion conductivity and interparticular pores formed between the particles; a solid electrolyte layer positioned on the anode layer; a cathode active material layer positioned on the solid electrolyte layer; and a cathode current collector positioned on the cathode active material layer.

### CROSS-REFERENCE TO RELATED APPLICATION

This application claims under 35 U.S.C. §119(a) the benefit of priority to Korean Patent Application No. 10-2022-0038483 filed on Mar. 29, 2022, the entire contents of which are incorporated herein by reference.

### TECHNICAL FIELD

The present invention relates to an all-solid-state battery including an anode layer containing interparticular pores and an operation method thereof.

### BACKGROUND

Components of an all-solid-state battery are all made of solid so that there is less risk of fire, explosion, or the like than a lithium-ion battery that uses a combustible organic solvent as an electrolyte. Further, since a solid electrolyte included in the all-solid-state battery has high mechanical strength, there is no problem in safety even when lithium metal is used as an anode active material. And if lithium is used as an anode active material, but lithium is not included during battery assembly, and an anode-free structure in which lithium supplied from a cathode active material is precipitated on an anode current collector is applied, the energy density can be greatly increased.

However, low coulombic efficiency and short lifespan in the charging and discharging process have been major obstacles to the commercialization of anode-free all-solid-state batteries. For example, due to lithium deposition and dissolution during charging and discharging, the interface between the anode layer and the solid electrolyte layer is separated and adhered repeatedly. It is resulted in unstable interfacial contact and a large increase in interfacial resistance. Unstable interfacial contact may cause non-uniform lithium deposition, and may lead to internal disconnection due to the growth of dendritic lithium. For this reason, all-solid-state batteries have been operated under high-temperature and high-pressure conditions in order to improve interfacial contact and lower interfacial resistance in many studies, which leads to an increase in process cost and a decrease in energy efficiency.

In order to develop an all-solid-state battery with an anode-free structure that can be stably driven at low temperatures and low pressures, it is necessary to enable charging and discharging without interfacial separation between the anode layer and the solid electrolyte layer.

### SUMMARY

In preferred aspects, provided is an all-solid-state battery having an anode-free structure that can be reversibly driven at room temperature for a long time.

A term “all-solid state battery” as used herein refers to a rechargeable secondary battery that includes an electrolyte in a solid state for transferring ions between the electrodes of the battery.

The objects of the present disclosure are not limited to the object mentioned above. The objects of the present disclosure will become clearer from the following description, and will be realized by means and combinations thereof described in the claims.

In an aspect, provided is an all-solid-state battery that may include: an anode current collector; an anode layer disposed on the anode current collector and comprises particles which do not have lithium ion conductivity and interparticular pores formed between the particles; a solid electrolyte layer disposed on the anode layer; a cathode active material layer disposed on the solid electrolyte layer; and a cathode current collector disposed on the cathode active material layer.

The term “interparticular pores” as used herein refers to a space or vacancy formed between particles. The interparticular pores may be formed with regular distribution of such vacancy or irregular arrangement of vacancy. The interparticular pores may be open to outside of the anode layer and include various shapes of internal cavities such as a pore, an open-ended or closed hole, a labyrinth, a channel, or the like. Size dimension (diameter or width) of the interparticular pores may vary from several nanometer scale to hundreds micrometer scale, without limitation. In particular, the interparticular pores may provide a path for lithium ion conductivity.

The particles may include metal particles, organic-particles, inorganic particles, or combinations thereof.

The particles may include nickel (Ni), iron (Fe), aluminum (Al), or combinations thereof.

The particles may have a spherical shape.

The particles may have an average diameter of about 500 nm or less.

The interparticular pores may have an average diameter of about 160 nm or less.

The particles may include a carbon coating layer formed on their surfaces.

The carbon coating layer may have a thickness of about 10 nm or less.

The anode layer may further include a metal component capable of alloying with lithium.

The term “metal component” as used herein refers to an elemental metal, which may be unmodified, modified with functional group or processed, or a compound (e.g., covalent compound, ionic compound, or salt) including one or more metal elements in its molecular formula. Preferred metal components may exist in an ionic compound (e.g., metal halide, metal nitrate, metal carbonate) or salt form thereof, which can dissociate into cation and anion in a polar solvent (e.g., aqueous solution, alcohol or polar aprotic solvent).

The metal component may include one or more selected from the group consisting of silver (Ag), zinc (Zn), magnesium (Mg), bismuth (Bi), and tin (Sn).

The anode layer may have a thickness of about 10 µm to 30 µm.

The all-solid-state battery may include lithium precipitated and stored inside the anode layer during charging.

In an aspect, provided is a method of operating the all-solid-state battery as described herein. The method may be charging and discharging the all-solid-state battery at a temperature of about 30° C. to 45° C.

The method include be charging and discharging the all-solid-state battery in a state in which a pressure of about 1 MPa to 10 MPa is applied in the lamination direction of the anode current collector, the anode layer, the solid electrolyte layer, the cathode active material layer, and the cathode current collector.

Thus, the disclosure provides the all-solid-state battery having an anode-free structure that can be reversibly driven at room temperature for a long time can be obtained.

Also provided is a vehicle including the all-solid-state battery as described herein.

Other aspects of the invention are disclosed infra.

### BRIEF DESCRIPTION OF THE DRAWINGS

FIG. 1 shows an exemplary all-solid-state battery according to an exemplary embodiment of the present invention.

FIG. 2 shows a reference diagram for explaining the internal structure of an exemplary anode layer according to an exemplary embodiment of the present invention.

FIG. 3A shows a scanning electron microscope (SEM) analysis result of the nickel particles of Comparative Preparation Example 1.

FIG. 3B shows an SEM analysis result of the nickel particles of Comparative Preparation Example 2.

FIG. 3C shows an SEM analysis result of the nickel particles of Preparation Example 1.

FIG. 4 shows results of measuring interparticular pore sizes of the respective anode layers through mercury intrusion porosimetry.

FIG. 5A shows a result of analyzing a cross section of the anode layer according to Comparative Preparation Example 1 with a scanning electron microscope.

FIG. 5B shows a result of analyzing a cross section of the anode layer according to Comparative Preparation Example 2 with a scanning electron microscope.

FIG. 5C shows a result of analyzing a cross section of the anode layer according to Preparation Example 1 with a scanning electron microscope.

FIG. 5D shows a result of different scale from that of FIG. 5A.

FIG. 5E shows a result of different scale from that of FIG. 5B.

FIG. 5F shows a result of different scale from that of FIG. 5C.

FIG. 6A shows a result of analyzing a cross section of the half-cell according to Comparative Example 1 with a scanning electron microscope.

FIG. 6B shows a result of different scale from that of FIG. 6A.

FIG. 6C shows a result of analyzing a cross section of the half-cell according to Comparative Example 2 with a scanning electron microscope.

FIG. 6D shows a result of analyzing the vicinity of the solid electrolyte layer at a different scale from that of FIG. 6C.

FIG. 6E shows a result of analyzing the vicinity of the anode current collector at a different scale from that of FIG. 6C.

FIG. 6F shows a result of analyzing a cross section of the half-cell according to Example 1 with a scanning electron microscope.

FIG. 6G shows a result of analyzing the vicinity of the solid electrolyte layer at a different scale from that of FIG. 6F.

FIG. 6H shows a result of analyzing the vicinity of the anode current collector at a different scale from that of FIG. 6F.

FIG. 7A shows a result of analyzing the surface of the anode layer according to Comparative Example 1 with a scanning electron microscope.

FIG. 7B shows a result of analysis at a different scale from that of FIG. 7A.

FIG. 7C shows a result of analyzing the surface of the anode layer according to Comparative Example 2 with a scanning electron microscope.

FIG. 7D shows a result of analysis at a different scale from that of FIG. 7C.

FIG. 7E shows a result of analyzing the surface of the anode layer according to Example 1 with a scanning electron microscope.

FIG. 7F shows a result of analysis at a different scale from that of FIG. 7E.

FIG. 8A shows a result of analyzing the anode layer material of Preparation Example 2 with a transmission electron microscope (TEM).

FIG. 8B shows an energy dispersive X-ray spectroscopy mapping (EDS-mapping) result for the nickel element of the anode layer material according to Preparation Example 2.

FIG. 8C shows an EDS-mapping result for the silver element of the anode layer material according to Preparation Example 2.

FIG. 8D shows an EDS-mapping result for the carbon element of the anode layer material according to Preparation Example 2.

FIG. 8E shows a result of analyzing the carbon coating layer of the anode layer material according to Preparation Example 2 with a high-resolution transmission electron microscope (HR-TEM).

FIG. 8F shows a result of analyzing the anode layer material of Preparation Example 2 with a secondary electron SEM.

FIG. 8G shows a result of analyzing the anode layer material of Preparation Example 2 with a backscattered electron SEM.

FIG. 9A shows a result of analyzing a cross section of the half-cell according to Example 2 with a scanning electron microscope.

FIG. 9B shows a result of analyzing the vicinity of the solid electrolyte layer at a different scale from that of FIG. 9A.

FIG. 9C shows a result of analyzing the vicinity of the anode current collector at a different scale from that of FIG. 9A.

FIG. 9D shows a result of analyzing the surface of the anode layer according to Example 2 with a scanning electron microscope.

FIG. 9E shows an EDS-mapping result for the nickel element in the anode layer according to Example 2.

FIG. 9F shows an EDS-mapping result for the silver element in the anode layer according to Example 2.

FIG. 9G shows an EDS-mapping result for the sulfur element in the anode layer according to Example 2.

FIG. 9H shows a result of depositing lithium on the anode layer according to Example 2 and desorbing lithium up to 1 V, and then analyzing a cross section thereof with a scanning electron microscope.

FIG. 10A shows a cycle-coulombic efficiency graph of the half-cells according to Example 2 and Comparative Example 3.

FIG. 10B shows a lithium deposition voltage profile of the first cycle of the half-cells according to Example 2 and Comparative Example 3.

FIG. 10C shows impedance spectroscopic analysis results according to the cycles of Example 2 and Comparative Example 3.

FIG. 11A shows a result of analyzing a cross section of the half-cell according to Example 4 with a scanning electron microscope.

FIG. 11B shows a result of analyzing the vicinity of the solid electrolyte layer at a different scale from that of FIG. 11A.

FIG. 11C shows a result of analyzing the vicinity of the anode current collector at a different scale from that of FIG. 11A.

FIG. 11D shows a result of analyzing the surface of the anode layer according to Example 4 with a scanning electron microscope.

FIG. 11E shows an EDS-mapping result for the nickel element in the anode layer according to Example 4.

FIG. 11F shows an EDS-mapping result for the silver element in the anode layer according to Example 4.

FIG. 11G shows an EDS-mapping result for the sulfur element in the anode layer according to Example 4.

FIG. 11H shows a result of depositing lithium on the anode layer according to Example 4 and desorbing lithium up to 1 V, and then analyzing a cross section thereof with a scanning electron microscope.

FIG. 12A shows a cycle-coulombic efficiency graph of the half-cells according to Example 3, Example 4, and Comparative Example 4.

FIG. 12B shows a lithium deposition voltage profile of the first cycle of the half-cells according to Example 3, Example 4, and Comparative Example 4.

### DETAILED DESCRIPTION

The above objects, other objects, features and advantages of the present disclosure will be easily understood through the following preferred embodiments related to the accompanying drawings. However, the present disclosure is not limited to the embodiments described herein and may be embodied in other forms. Rather, the embodiments introduced herein are provided so that the disclosed content may become thorough and complete, and the spirit of the present disclosure may be sufficiently conveyed to those skilled in the art.

In the present specification, terms such as “comprise”, “have”, etc. are intended to designate that a feature, number, step, operation, component, part, or a combination thereof described in the specification exists, but it should be understood that the terms do not preclude the possibility of the existence or addition of one or more other features, numbers, steps, operations, components, parts, or combinations thereof. Further, when a part of a layer, film, region, plate, etc. is said to be “on” other part, this includes not only the case where it is “directly on” the other part but also the case where there is another part in the middle thereof. Conversely, when a part of a layer, film, region, plate, etc. is said to be “under” other part, this includes not only the case where it is “directly under” the other part, but also the case where there is another part in the middle thereof.

Unless otherwise specified, since all numbers, values, and/or expressions expressing quantities of components, reaction conditions, polymer compositions and formulations used in the present specification are approximate values reflecting various uncertainties of the measurement that arise in obtaining these values among others in which these numbers are essentially different, they should be understood as being modified by the term “about” in all cases. Further, unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about.”

Further, when a numerical range is disclosed in this description, such a range is continuous, and includes all values from a minimum value of such a range to a maximum value including the maximum value, unless otherwise indicated. Furthermore, when such a range refers to an integer, all integers including from a minimum value to a maximum value including the maximum value are included, unless otherwise indicated.

In the present specification, when a range is described for a variable, it will be understood that the variable includes all values including the end points described within the stated range. For example, the range of “5 to 10” will be understood to include any subranges, such as 6 to 10, 7 to 10, 6 to 9, 7 to 9, and the like, as well as individual values of 5, 6, 7, 8, 9 and 10, and will also be understood to include any value between valid integers within the stated range, such as 5.5, 6.5, 7.5, 5.5 to 8.5, 6.5 to 9, and the like. Also, for example, the range of “10% to 30%” will be understood to include subranges, such as 10% to 15%, 12% to 18%, 20% to 30%, etc., as well as all integers including values of 10%, 11%, 12%, 13% and the like up to 30%, and will also be understood to include any value between valid integers within the stated range, such as 10.5%, 15.5%, 25.5%, and the like.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

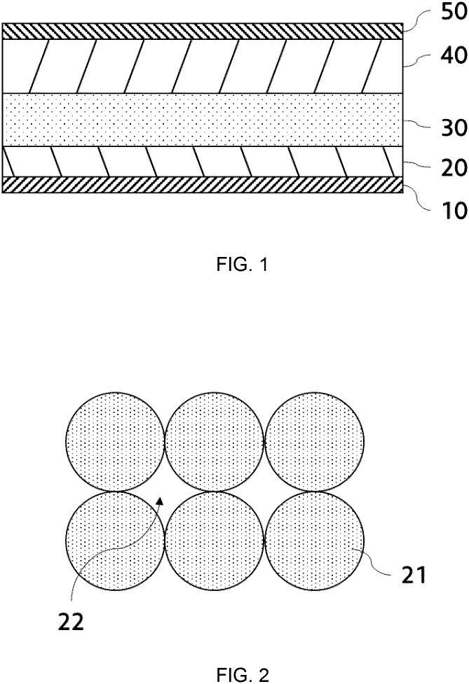

FIG. 1 shows an exemplary all-solid-state battery according to an exemplary embodiment of the present invention. The all-solid-state battery may include an anode current collector 10, an anode layer 20, a solid electrolyte layer 30, a cathode active material layer 40, and a cathode current collector 50, which are laminated.

The anode current collector 10 may be a plate-shaped substrate having electrical conductivity. The anode current collector 10 may suitably be in the form of a sheet, a thin film, or a foil.

The anode current collector 10 may include a material that does not react with lithium. Particularly, the anode current collector 10 may include nickel (Ni), copper (Cu), stainless steel (SUS), or combinations thereof.

FIG. 2 shows an exemplary internal structure of an exemplary anode layer 20 according to an exemplary embodiment of the present invention. The anode layer 20 may include particles 21 and interparticular pores 22.

Preferably, the lithium ions that have moved from the cathode active material layer 40 during charging of the all-solid-state battery may be precipitated and stored in the anode layer 20 so that the interface between the anode layer 20 and the solid electrolyte layer 30 is not separated. Particularly, the interface between the anode layer 20 and the solid electrolyte layer 30 may be prevented from being separated by filling the interparticular pores 22 with lithium through a creep phenomenon. When lithium is precipitated and stored between the anode layer 20 and the solid electrolyte layer 30, the interface between both of the components may be separated so that the interfacial contact becomes unstable, and the interfacial resistance is greatly increased. The creep phenomenon means that the morphological deformation is continued over time in a situation in which a stress less than or equal to the yield strength is applied to a specific material. Thus, according to the exemplary embodiments of the present invention, lithium may be stored through diffusion coble creep during the creep phenomenon, and since diffusion coble creep occurs at low temperatures, it is advantageous for low-temperature operating of an all-solid-state battery.

The particles 21 may not have lithium ion conductivity. Since the particles 21 do not have lithium ion conductivity, the reduction reaction of lithium ions occurs at the interface between the anode layer 20 and the solid electrolyte layer 30, not inside the anode layer 20. Thereafter, operating temperature and pressure, which will be described later, are applied to lithium precipitated at the interface so that lithium is filled in the interparticular pores 22 through diffusion coble creep.

The particles 21 may include metal particles, organic-particles, inorganic particles, or combinations thereof.

The metal particles may include nickel (Ni), iron (Fe), aluminum (Al), or combinations thereof.

The organic-particles may include a carbon material, and the inorganic particles may include silica, Li[Li_{⅓}Ti_{5/3}]O₄ (LTO), and the like.

The particles 21 may have a spherical shape. However, the particles 21 may have an oval shape, a polygonal shape, or the like capable of forming the interparticular pores 22.

The particles 21 may have an average diameter of about 500 nm or less. The average diameter of the particles 21 is a factor determining the average diameter of the interparticular pores 22, and when it falls within the above numerical range, interparticular pores 22 may be formed to have an average diameter of a desired degree in exemplary embodiments of the present invention. The lower limit of the average diameter of the particles 21 is not particularly limited, and may be, for example, about 100 nm or greater, about 200 nm or greater, or about 300 nm or greater.

The interparticular pore 22 refers to an empty space existing between one particle 21 and another adjacent particle 21.

The interparticular pores 22 may have an average diameter of about 160 nm or less. The average diameter of the interparticular pores 22 may be a value measured through mercury intrusion porosimetry. Mercury intrusion porosimetry is a method for obtaining the total pore volume, pore size and distribution, pore surface area, and the like based on the intruded amount by intruding mercury into the pores of a sample by applying pressure from the outside, and measurement may be performed using a mercury porosimeter. When the average diameter of the interparticular pores 22 is within the above numerical range, lithium may easily enter the anode layer 20 through the creep phenomenon. The lower limit of the average diameter of the interparticular pores 22 is not particularly limited, and may be, for example, about 30 nm or greater, about 40 nm or greater, or about 50 nm or greater.

The anode layer 20 may include a carbon coating layer formed on the surface of the particles 21. When the carbon coating layer is formed, electrons may be conducted over the entire surface of the interparticular pores 22 so that lithium may be more easily electrodeposited and desorbed within the interparticular pores 22.

The carbon coating layer may have a thickness of about 10 nm or less. The lower limit of the thickness of the carbon coating layer is not particularly limited, and may be about 0.1 nm, about 1 nm, about 2 nm, about 3 nm, about 4 nm, or about 5 nm or greater.

A method of forming the carbon coating layer is not particularly limited. For example, after coating the particles 21 with a hydrocarbon-based polymer, the carbon coating layer may be formed by heat-treating the resultant product, thereby carbonizing the polymer.

Further, the anode layer 20 may further include a metal component capable of alloying with lithium. The metal component forms an alloy phase with lithium, and since the alloy phase has high lithium ion conductivity compared to lithium metal, the metal component may be of great help in improving lithium ion conductivity in the anode layer 20.

The metal component may include silver (Ag), zinc (Zn), magnesium (Mg), bismuth (Bi), tin (Sn), or combinations thereof.

In order to evenly disperse the metal material in the anode layer 20, the particles 21 and a precursor of the metal component may be uniformly mixed, and then the precursor may be reduced. However, a method of introducing the metal component is not limited thereto, and any method may be used as long as it enables the metal component to be evenly dispersed.

The anode layer 20 may have a thickness of about 10 µm to 30 µm. When the anode layer 20 has a thickness of less than about 10 µm, it may be difficult to accommodate all lithium precipitated during charging, and when the anode layer 20 has a thickness of greater than about 30 µm, the energy density of the all-solid-state battery may deteriorate.

The solid electrolyte layer 30 is interposed between the cathode active material layer 40 and the anode layer 20 and conducts lithium ions.

The solid electrolyte layer 30 may include a solid electrolyte having lithium ion conductivity.

The solid electrolyte may include at least one selected from the group consisting of an oxide-based solid electrolyte, a sulfide-based solid electrolyte, a polymer electrolyte, and combinations thereof. However, it may be preferable to use a sulfide-based solid electrolyte having high lithium ion conductivity. The sulfide-based solid electrolyte is not particularly limited, but may include Li₂S—P₂S₅, Li₂S—P₂S₅—LiI, Li₂S—P₂S₅—LiCl, Li₂S—P₂S₅—LiBr, Li₂S—P₂S₅—Li₂O, Li₂S—P₂S₅—Li₂O—LiI, Li₂S—SiS₂, Li₂S—SiS₂—LiI, Li₂S—SiS₂—LiBr, Li₂S—SiS₂—LiCl, Li₂S—SiS₂—B₂S₃—LiI, Li₂S—SiS₂—P₂S₅—LiI, Li₂S—B₂S₃, Li₂S—P₂S₅—ZₘSₙ (provided that m and n are positive numbers, and Z is one of Ge, Zn, and Ga), Li₂S—GeS₂, Li₂S—SiS₂—Li₃PO₄, Li₂S—SiS₂—LiₓMO_{y} (provided that x and y are positive numbers, and M is one of P, Si, Ge, B, Al, Ga, and In), Li₁₀GeP₂S₁₂, or the like.

The oxide-based solid electrolyte may include perovskite-type Li₃ₓLa_{⅔-x}TiO₃ (LLTO), phosphate-based NASICON type Li₁₊ₓAlₓTi₂₋ₓ(PO₄)₃ (LATP), and the like.

The polymer electrolyte may include a gel polymer electrolyte, a solid polymer electrolyte, and the like.

The solid electrolyte layer 30 may further include a binder. The binder may include butadiene rubber, nitrile butadiene rubber, hydrogenated nitrile butadiene rubber, polyvinylidene fluoride (PVDF), polytetrafluoroethylene (PTFE), carboxymethyl cellulose (CMC), and the like.

The cathode active material layer 40 may occlude and release lithium ions reversibly. The cathode active material layer 40 may include a cathode active material, a solid electrolyte, a conductive material, a binder, and the like.

The cathode active material may include an oxide active material or a sulfide active material.

The oxide active material may include a rock salt layer-type active material such as LiCoO₂, LiMnO₂, LiNiO₂, LiVO₂, Li₁₊ₓNi_{⅓}Co_{⅓}Mn_{⅓}O₂, or the like, a spinel-type active material such as LiMn₂O₄, Li(Ni_{0.5}Mn_{1.5})O₄, or the like, a reverse spinel-type active material such as LiNiVO₄, LiCoVO₄, or the like, an olivine-type active material such as LiFePO₄, LiMnPO₄, LiCoPO₄, LiNiPO₄, or the like, a silicon-containing active material such as Li₂FeSiO₄, Li₂MnSiO₄, or the like, a rock salt layer-type active material in which a part of the transition metal is substituted with a dissimilar metal, such as LiNi_{0.8}Co_{(0.2-x)}ALₓO₂ (0<x<0.2), a spinel-type active material in which a part of the transition metal is substituted with a dissimilar metal, such as Li₁₊ₓMn_{2-x-y}M_{y}O₄ (M is at least one of Al, Mg, Co, Fe, Ni, and Zn, and 0 < x+y < 2), or a lithium titanate such as Li₄Ti₅O₁₂ or the like.

The sulfide active material may include copper chevrel, iron sulfide, cobalt sulfide, nickel sulfide, or the like.

The solid electrolyte may include at least one selected from the group consisting of an oxide-based solid electrolyte, a sulfide-based solid electrolyte, a polymer electrolyte, and combinations thereof. However, it may be preferable to use a sulfide-based solid electrolyte having high lithium ion conductivity. The sulfide-based solid electrolyte is not particularly limited, but may include Li₂S—P₂S₅, Li₂S—P₂S₅—LiI, Li₂S—P₂S₅—LiCl, Li₂S—P₂S₅—LiBr, Li₂S—P₂S₅—Li₂O, Li₂S—P₂S₅—Li₂O—LiI, Li₂S—SiS₂, Li₂S—SiS₂—LiI, Li₂S—SiS₂—LiBr, Li₂S—SiS₂—LiCl, Li₂S—SiS₂—B₂S₃—LiI, Li₂S—SiS₂—P₂S₅—LiI, Li₂S—B₂S₃, Li₂S—P₂S₅—ZₘSₙ (provided that m and n are positive numbers, and Z is one of Ge, Zn, and Ga), Li₂S—GeS₂, Li₂S—SiS₂—Li₃PO₄, Li₂S—SiS₂—LiₓMO_{y} (provided that x and y are positive numbers, and M is one of P, Si, Ge, B, Al, Ga, and In), Li₁₀GeP₂S₁₂, or the like.

The oxide-based solid electrolyte may include perovskite-type Li₃ₓLa_{2/}₃₋ₓTiO₃ (LLTO), phosphate-based NASICON type Li₁₊ₓAlₓTi₂₋ₓ(PO₄)₃ (LATP), and the like.

The polymer electrolyte may include a gel polymer electrolyte, a solid polymer electrolyte, and the like.

The conductive material may be carbon black, conductive graphite, ethylene black, carbon fiber, graphene, or the like.

The binder may include butadiene rubber, nitrile butadiene rubber, hydrogenated nitrile butadiene rubber, polyvinylidene fluoride (PVDF), polytetrafluoroethylene (PTFE), carboxymethyl cellulose (CMC), and the like.

The cathode current collector 50 may be a plate-shaped substrate having electrical conductivity. Preferably, the cathode current collector 50 may be in the form of a sheet or a thin film.

The cathode current collector 50 may include at least one selected from the group consisting of indium, copper, magnesium, aluminum, stainless steel, iron, and combinations thereof.

The operating method of an all-solid-state battery may include steps of charging and discharging the all-solid-state battery at a temperature of about 30° C. to 45° C. in a state in which a operating pressure of about 1 MPa to 10 MPa is applied in the lamination direction of the anode current collector 10, the anode layer 20, the solid electrolyte layer 30, the cathode active material layer 40, and the cathode current collector 50. Since lithium can be stored in the anode layer 20 through diffusion coble creep, it is advantageous to drive the all-solid-state battery at low temperatures and low pressures, which are occurrence conditions for diffusion coble creep.

### EXAMPLE

Hereinafter, the present disclosure will be described in more detail through Examples. The following Examples are merely illustrative to help the understanding of the present disclosure, and the scope of the present disclosure is not limited thereto.

### Preparation Example 1, Comparative Preparation Example 1, and Comparative Preparation Example 2

Nickel particles having different average diameters were prepared as follows.

Comparative Preparation Example 1: Nickel particles having an average diameter of 3.58 µm
Comparative Preparation Example 2: Nickel particles having an average diameter of 504 nm

### Preparation Example 1: Nickel Particles Having an Average Diameter of 314 Nm

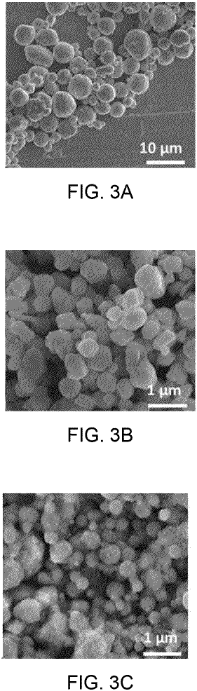

FIG. 3A is a scanning electron microscope (SEM) analysis result of the nickel particles of Comparative Preparation Example 1. FIG. 3B is an SEM analysis result of the nickel particles of Comparative Preparation Example 2. FIG. 3C is an SEM analysis result of the nickel particles of Preparation Example 1.

The respective nickel particles were cast on a substrate to form anode layers with certain thicknesses. No separate pressure was applied to maintain the interparticular pores.

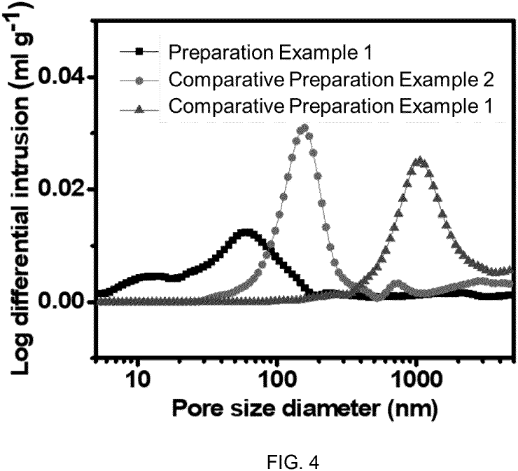

FIG. 4 is results of measuring interparticular pore sizes of the respective anode layers through mercury intrusion porosimetry. The interparticular pores of the anode layers according to Comparative Preparation Example 1, Comparative Preparation Example 2, and Preparation Example 1 had average diameters of 1.44 µm, 163 nm, and 56.8 nm respectively.

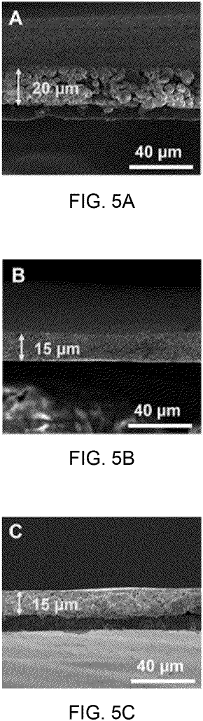

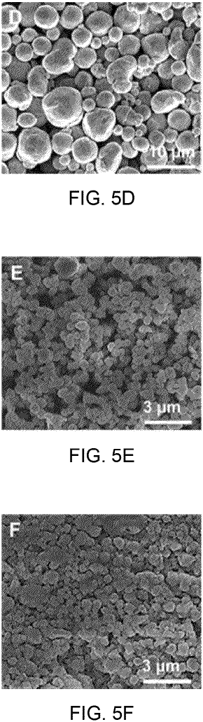

FIG. 5A shows a result of analyzing a cross section of the anode layer according to Comparative Preparation Example 1 with a scanning electron microscope. FIG. 5B shows a result of analyzing a cross section of the anode layer according to Comparative Preparation Example 2 with a scanning electron microscope. FIG. 5C shows a result of analyzing a cross section of the anode layer according to Preparation Example 1 with a scanning electron microscope. FIG. 5D shows a result of different scale from that of FIG. 5A. FIG. 5E shows a result of different scale from that of FIG. 5B. FIG. 5F shows a result of different scale from that of FIG. 5C. As shown in FIGS. 5A-5F, the shape of the nickel particles in the anode layer and the interparticular pores were maintained.

### Example 1, Comparative Example 1, and Comparative Example 2

Half-cells comprising the anode layers according to Preparation Example 1, Comparative Preparation Example 1, and Comparative Preparation Example 2 were manufactured.

A method for manufacturing the half-cells is as follows.

A solid electrolyte layer: manufactured by putting 90 mg of Li₃PS₄ (NEI Corporation) into a mold with an inner diameter of 10 mm and pressing it at 380 MPa.

Improvement of anode layer-solid electrolyte layer interfacial contact: The anode layer was placed on one surface of the solid electrolyte layer and pressed at 200 MPa.

Battery assembly: The half-cells were manufactured by attaching a lithium foil (Honjo Chemical Corporation) having a thickness of 200 µm to the other surface of the solid electrolyte layer, and an operating pressure of 5 MPa was applied to the half-cells using a spring.

Lithium was deposited on the respective half-cells under the conditions of a operating temperature of 45° C., a current density of 0.5 mA·cm⁻², and a capacity of 2 mAh·cm⁻² to evaluate their behaviors.

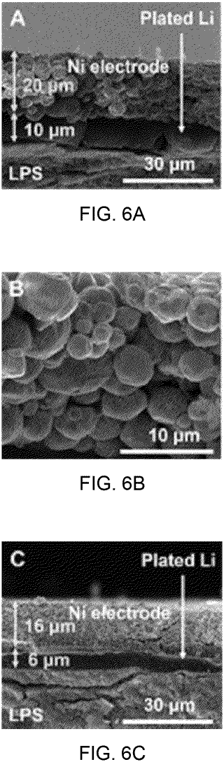

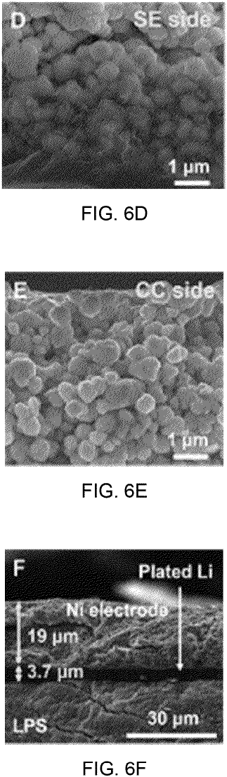

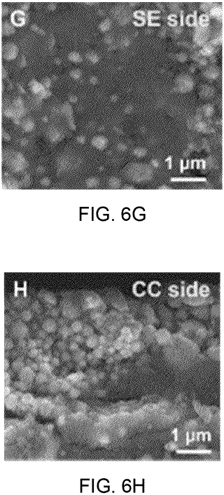

FIG. 6A is a result of analyzing a cross section of the half-cell according to Comparative Example 1 with a scanning electron microscope. FIG. 6B is a result of different scale from that of FIG. 6A. As shown in FIGS. 6A and 6B, there was no change in the thickness of the anode layer, and a lithium layer of about 10 µm was formed between the anode layer (Ni electrode) and the solid electrolyte layer (LPS). In particular, in the half-cell according to Comparative Example 1, all lithium was deposited at the interface between the solid electrolyte layer (LPS) and the anode layer, and was not found at all in the interparticular pores inside the anode layer.

FIG. 6C shows a result of analyzing a cross section of the half-cell according to Comparative Example 2 with a scanning electron microscope. FIG. 6D shows a result of analyzing the vicinity of the solid electrolyte layer at a different scale from that of FIG. 6C. FIG. 6E shows a result of analyzing the vicinity of the anode current collector at a different scale from that of FIG. 6C. As shown in FIGS. 6C-6E, the thickness of the lithium layer produced at the interface between the solid electrolyte layer (LPS) and the anode layer (Ni electrode) was reduced compared to Comparative Example 1, and some lithium was deposited inside the anode layer. As show in FIG. 6D, lithium surrounds the nickel particles. However, as shown in FIG. 6E, lithium was not found at all in a portion far from the solid electrolyte layer. This indicates that lithium was deposited on only a part of the anode layer.

FIG. 6F shows a result of analyzing a cross section of the half-cell according to Example 1 with a scanning electron microscope. FIG. 6G shows a result of analyzing the vicinity of the solid electrolyte layer at a different scale from that of FIG. 6F. FIG. 6H shows a result of analyzing the vicinity of the anode current collector at a different scale from that of FIG. 6F. The thickness of the lithium layer produced at the interface between the solid electrolyte layer (LPS) and the anode layer (Ni electrode) was further reduced. As shown in FIGS. 6G and 6H, lithium was deposited on the entire anode layer.

Based on the the above results, lithium may enter the inside of the anode layer much better as the size of the interparticular pores is reduced, and the thickness also increases as the anode layer accommodates greater amount of lithium.

Since nickel particles do not exhibit lithium ion conductivity at all, the reduction reaction of lithium ions may occur at the interface between the anode layer and the solid electrolyte layer, and the morphological deformation of lithium may occur by the pressure due to the precipitation of lithium so that lithium fills the inside of the interparticular pores.

Further, lithium may easily fill the inside of the interparticular pores when the size of the interparticular pores is reduced under the condition of applying the same operating pressure of 5 MPa. As the average diameter of the interparticular pores decreases, the morphological deformation of lithium actively occurs at low pressures. This may be similar to the occurrence conditions for diffusion coble creep in the morphological deformation of metals. Therefore, the main mechanism in which lithium fills the interparticular pores between the nickel particles in the present disclosure may be referred to as diffusion coble creep.

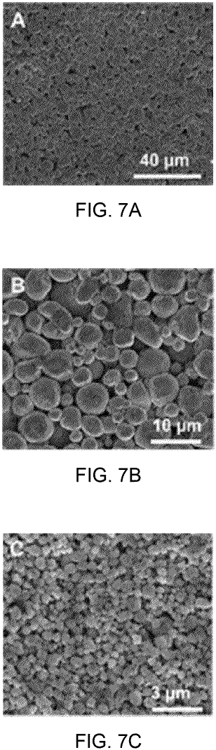

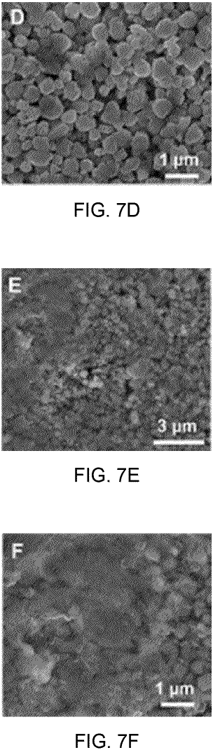

FIG. 7A shows a result of analyzing the surface of the anode layer according to Comparative Example 1 with a scanning electron microscope. The surface of the anode current collector side of the anode layer was analyzed. FIG. 7B shows a result of analysis at a different scale from that of FIG. 7A. FIG. 7C shows a result of analyzing the surface of the anode layer according to Comparative Example 2 with a scanning electron microscope. FIG. 7D shows a result of analysis at a different scale from that of FIG. 7C. FIG. 7E shows a result of analyzing the surface of the anode layer according to Example 1 with a scanning electron microscope. FIG. 7F shows a result of analysis at a different scale from that of FIG. 7E. As shown in FIGS. 7A to 7F, deposited lithium was found only in Example 1.

### Preparation Example 2

The nickel particles used in Preparation Example 1 were prepared. The nickel particles were injected into triethylene glycol, and heated to a temperature of about 220° C. to form a polymer coating layer on the surface of the nickel particles.

The above resultant product was injected into ethylene glycol together with silver nitrate (AgNO₃) and stirred to reduce silver (Ag), the metal component, on the surface of the nickel particles.

The above resultant product was heat-treated at a temperature of about 700° C. in an argon gas atmosphere, and the polymer coating layer was carbonized to form a carbon coating layer.

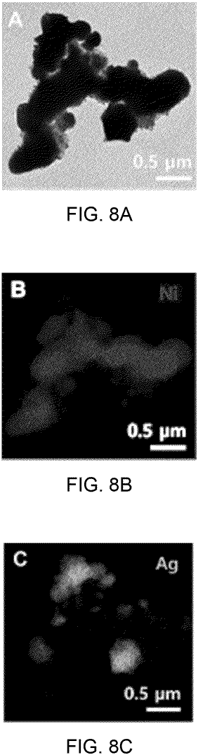

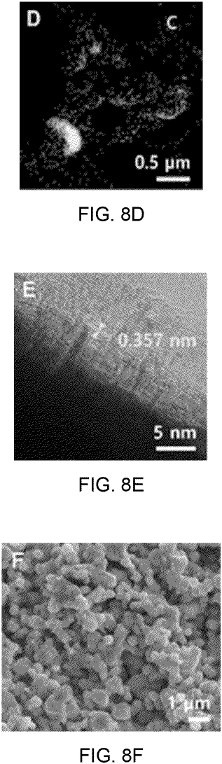

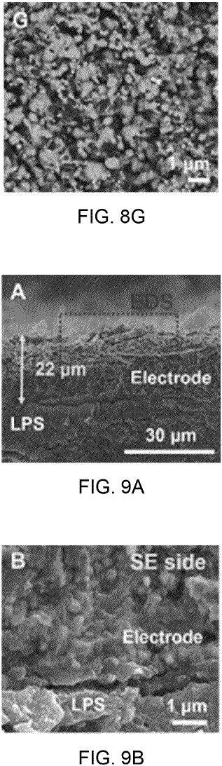

FIG. 8A shows a result of analyzing the anode layer material of Preparation Example 2 with a transmission electron microscope (TEM). FIG. 8B shows an energy dispersive X-ray spectroscopy mapping (EDS-mapping) result for the nickel element of the anode layer material according to Preparation Example 2. FIG. 8C shows an EDS-mapping result for the silver element of the anode layer material according to Preparation Example 2. FIG. 8D shows an EDS-mapping result for the carbon element of the anode layer material according to Preparation Example 2. As shown in FIGS. 8A to 8D, the carbon coating layer uniformly may cover the surface of the nickel particles, and silver (Ag) may be evenly mixed.

FIG. 8E shows a result of analyzing the carbon coating layer of the anode layer material according to Preparation Example 2 with a high-resolution transmission electron microscope (HR-TEM). As shown in FIG. 8E, the carbon coating layer may have graphitized crystallinity.

FIG. 8F shows a result of analyzing the anode layer material of Preparation Example 2 with a secondary electron SEM. FIG. 8G shows a result of analyzing the anode layer material of Preparation Example 2 with a backscattered electron SEM. As shown in FIGS. 8F and 8G, the nickel particles and silver (Ag) may be uniformly mixed.

The anode layer was formed in the same manner as in Preparation Example 1 using the above anode layer material.

### Example 1, Example 2, and Comparative Example 3

The half-cell according to Example 1 was used in an experiment to be described later. Example 2 is a half-cell comprising the anode layer according to Preparation Example 2. Comparative Example 3 is a half-cell using a nickel foil as the anode layer.

A method for manufacturing the half-cells according to Example 2 and Comparative Example 3 is as follows.

A solid electrolyte layer: manufactured by putting 90 mg of Li₃PS₄ (NEI Corporation) into a mold with an inner diameter of 10 mm and pressing it at 380 MPa.

Improvement of anode layer-solid electrolyte layer interface contact: The anode layer was placed on one surface of the solid electrolyte layer and pressed at 200 MPa.

Battery assembly: The half-cells were manufactured by attaching a lithium foil (Honjo Chemical Corporation) having a thickness of 200 µm to the other surface of the solid electrolyte layer, and an operating pressure of 5 MPa was applied to the half-cells using a spring.

Lithium was deposited on the respective half-cells under the conditions of an operating temperature of 45° C., a current density of 0.5 mA·cm⁻², and a capacity of 2 mAh·cm⁻² to evaluate their behaviors.

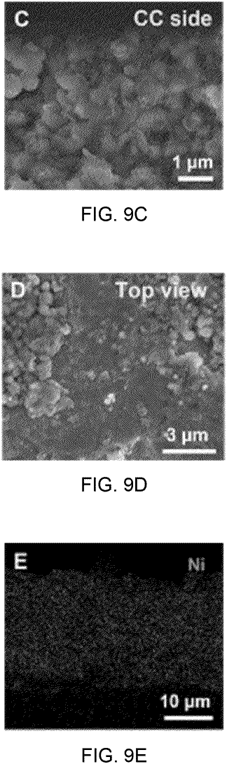

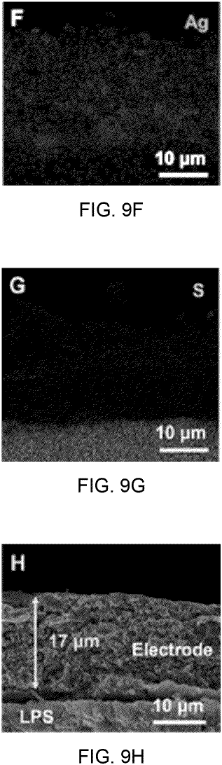

FIG. 9A shows a result of analyzing a cross section of the half-cell according to Example 2 with a scanning electron microscope. FIG. 9B shows a result of analyzing the vicinity of the solid electrolyte layer at a different scale from that of FIG. 9A. FIG. 9C shows a result of analyzing the vicinity of the anode current collector at a different scale from that of FIG. 9A. FIG. 9D shows a result of analyzing the surface of the anode layer according to Example 2 with a scanning electron microscope. As shown in FIGS. 9A to 9D, a lithium layer may not be found between the solid electrolyte layer and the anode layer. Therefore, all lithium was accommodated in the anode layer.

FIG. 9E shows an EDS-mapping result for the nickel element in the anode layer according to Example 2. FIG. 9F shows an EDS-mapping result for the silver element in the anode layer according to Example 2. FIG. 9G shows an EDS-mapping result for the sulfur element in the anode layer according to Example 2.

FIG. 9H shows a result of depositing lithium on the anode layer according to Example 2 and desorbing lithium up to 1 V, and then analyzing a cross section thereof with a scanning electron microscope. As shown in FIG. 9A, the anode layer thickened by deposition of lithium becomes thin again as lithium is desorbed.

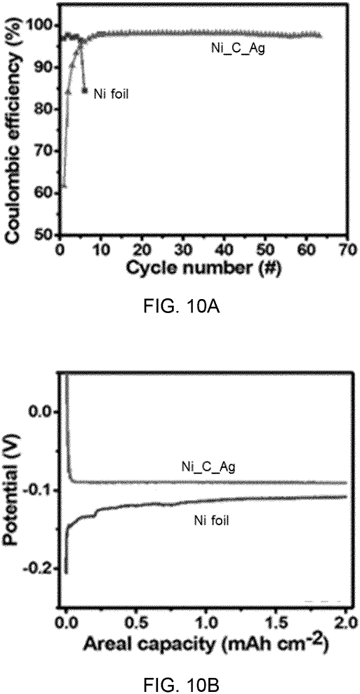

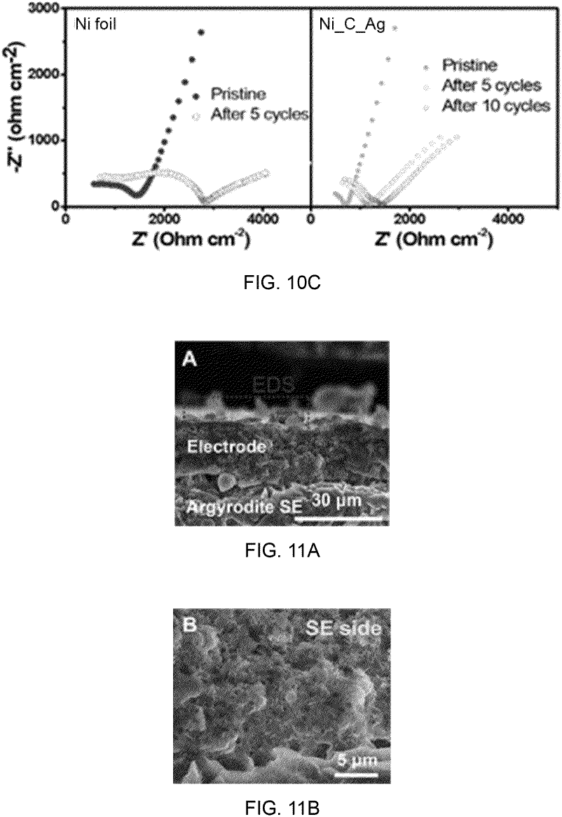

FIG. 10A shows a cycle-coulombic efficiency graph of the half-cells according to Example 2 and Comparative Example 3. Example 2 was represented by Ni_C_Ag, and Comparative Example 3 was represented by an Ni foil. FIG. 10B shows a lithium deposition voltage profile of the first cycle of the half-cells according to Example 2 and Comparative Example 3. FIG. 10C shows impedance spectroscopic analysis results according to the cycles of Example 2 and Comparative Example 3. The half-cell according to Example 2 was stably driven with an average coulombic efficiency of 96.8% for 60 cycles. Further, the overpotential also showed a value close to zero. In addition, Comparative Example 2 had a stably low value of the interfacial resistance even after repeated cycles compared to Example 1 and Comparative Example 3.

### Example 3, Example 4, and Comparative Example 4

Half-cells comprising the anode layers according to Preparation Examples 1 and 2 were manufactured as follows, and were used as Examples 3 and 4 respectively. Comparative Example 4 was a half-cell using a nickel foil as the anode layer.

A method for manufacturing the half-cells is as follows.

A solid electrolyte layer: manufactured by putting 90 mg of Li₆PS₅Cl_{0.5}Br_{0.5} into a mold with an inner diameter of 10 mm and pressing it at 380 MPa.

Improvement of anode layer-solid electrolyte layer interface contact: The anode layer was placed on one surface of the solid electrolyte layer and pressed at 200 MPa.

Battery assembly: The half-cells were manufactured by attaching a lithium foil (Honjo Chemical Corporation) having a thickness of 200 µm to the other surface of the solid electrolyte layer, and an operating pressure of 5 MPa was applied to the half-cells using a spring.

Lithium was deposited on the respective half-cells under the conditions of an operating temperature of 30° C., a current density of 0.5 mA·cm⁻², and a capacity of 2 mAh·cm⁻² to evaluate their behaviors.

Since Li₆PS₅Cl_{0.5}Br_{0.5}, a solid electrolyte, showed high lithium ion conductivity and low interfacial resistance even at low temperatures so that driving was possible at low temperatures, the experiment was performed at a temperature of 30° C.

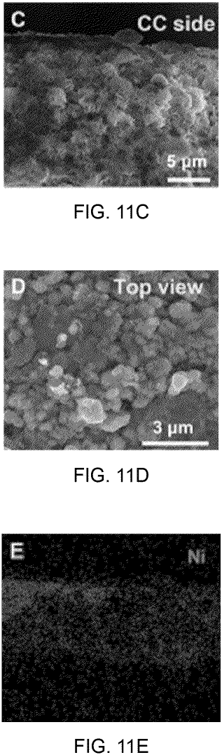

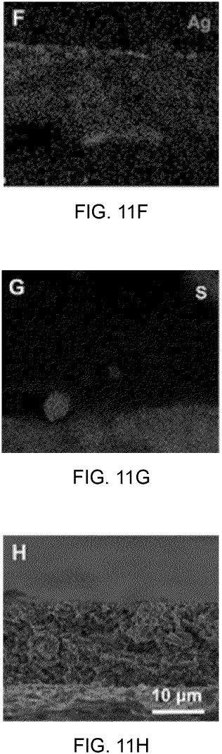

FIG. 11A shows a result of analyzing a cross section of the half-cell according to Example 4 with a scanning electron microscope. FIG. 11B shows a result of analyzing the vicinity of the solid electrolyte layer at a different scale from that of FIG. 11A. FIG. 11C shows a result of analyzing the vicinity of the anode current collector at a different scale from that of FIG. 11A. FIG. 11D shows a result of analyzing the surface of the anode layer according to Example 4 with a scanning electron microscope. As shown in FIGS. 11A-11D, a lithium layer was not found between the solid electrolyte layer and the anode layer. Therefore, all lithium was accommodated in the anode layer.

FIG. 11E shows an EDS-mapping result for the nickel element in the anode layer according to Example 4. FIG. 11F shows an EDS-mapping result for the silver element in the anode layer according to Example 4. FIG. 11G shows an EDS-mapping result for the sulfur element in the anode layer according to Example 4.

FIG. 11H shows a result of depositing lithium on the anode layer according to Example 4 and desorbing lithium up to 1 V, and then analyzing a cross section thereof with a scanning electron microscope. As shown in FIG. 11A, the anode layer thickened by deposition of lithium became thin again as lithium was desorbed.

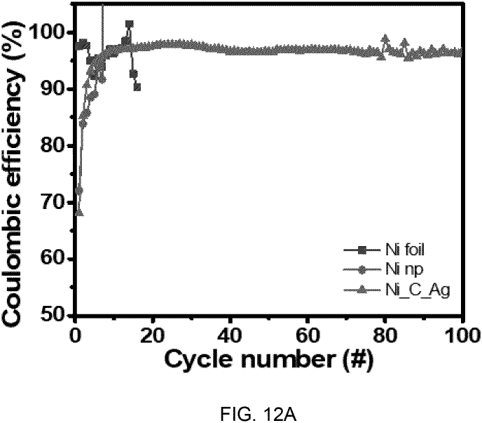

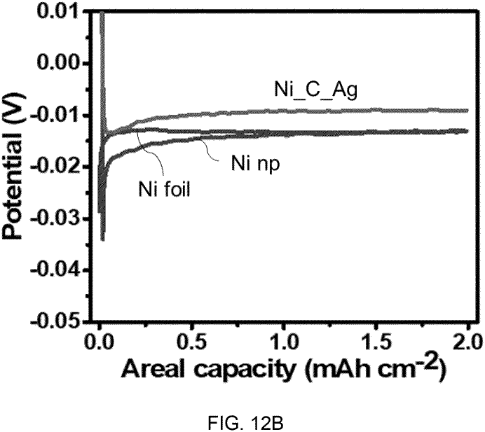

FIG. 12A shows a cycle-coulombic efficiency graph of the half-cells according to Example 3, Example 4, and Comparative Example 4. Example 3 was represented by Ni np, Example 4 was represented by Ni_C_Ag, and Comparative Example 4 was represented by an Ni foil. FIG. 12B shows a lithium deposition voltage profile of the first cycle of the half-cells according to Example 3, Example 4, and Comparative Example 4. The half-cell according to Example 4 was stably driven with an average coulombic efficiency of 96.3% for 100 cycles. Further, the overpotential was also very low, about 4.4 mV.

As the Examples of the present disclosure have been described in detail above, the right scope of the present disclosure is not limited to the above-described Examples, and various modifications and improved forms by those skilled in the art using the basic concept of the present disclosure as defined in the following claims are also included in the right scope of the present disclosure.

What is claimed is:

1. An all-solid-state battery comprising:
an anode current collector;
an anode layer disposed on the anode current collector and comprising particles which not have lithium ion conductivity and interparticular pores formed between the particles;
a solid electrolyte layer disposed on the anode layer;
a cathode active material layer disposed on the solid electrolyte layer; and
a cathode current collector disposed on the cathode active material layer.

2. The all-solid-state battery of claim 1, wherein the particles comprise metal particles, organic-particles, inorganic particles, or any combination thereof.

3. The all-solid-state battery of claim 1, wherein the particles comprise metal particles, and the metal particles comprise nickel (Ni), iron (Fe), aluminum (Al), or any combination thereof.

4. The all-solid-state battery of claim 1, wherein the particles have a spherical shape.

5. The all-solid-state battery of claim 1, wherein the particles have an average diameter of about 500 nm or less.

6. The all-solid-state battery of claim 1, wherein the interparticular pores have an average diameter of about 160 nm or less.

7. The all-solid-state battery of claim 1, wherein the particles have a carbon coating layer formed on their surfaces.

8. The all-solid-state battery of claim 7, wherein the carbon coating layer has a thickness of about 10 nm or less.

9. The all-solid-state battery of claim 1, wherein the anode layer further comprises a metal component capable of alloying with lithium.

10. The all-solid-state battery of claim 9, wherein the metal component comprises at least one of silver (Ag), zinc (Zn), magnesium (Mg), bismuth (Bi), tin (Sn), or any combination thereof.

11. The all-solid-state battery of claim 1, wherein the anode layer has a thickness of about 10 µm to 30 µm.

12. The all-solid-state battery of claim 1, wherein the all-solid-state battery comprises lithium precipitated and stored inside the anode layer during charging.

13. A method of operating the all-solid-state battery of claim 1, comprising charging and discharging the all-solid-state battery at a temperature of about 30° C. to 45° C.

14. The operating method of claim 13, wherein the all-solid-state battery is charged and discharged in a state in which a pressure of about 1 MPa to 10 MPa is applied in the lamination direction of the anode current collector, the anode layer, the solid electrolyte layer, the cathode active material layer, and the cathode current collector.

15. A vehicle comprising the all-solid-state battery of claim 1.
